(19) United States
(12) Patent Application Publication
(10) Pub. No.: US 2025/0243009 A1
(43) Pub. Date: Jul. 31, 2025

(54) SYSTEM FOR VISUALLY IDENTIFYING AND POSITIONING TEARING FAULT OF CONVEYER BELT OF MINING BELT CONVEYOR

(71) Applicant: Taiyuan University of Technology, Taiyuan City (CN)

(72) Inventors: Hua Ding, Taiyuan City (CN); Yongshuai Bian, Taiyuan City (CN); Guangyu Zheng, Taiyuan City (CN); Ning Li, Taiyuan City (CN); Xiaochun Sun, Taiyuan City (CN); Junhu Zhang, Taiyuan City (CN); Junjun Zhao, Taiyuan City (CN); Bao Wang, Taiyuan City (CN); Yiliang Wang, Taiyuan City (CN); Yaoyao Liao, Taiyuan City (CN)

(21) Appl. No.: 19/026,083

(22) Filed: Jan. 16, 2025

(30) Foreign Application Priority Data
Jan. 26, 2024 (CN) 202410111753.3

(51) Int. Cl. B65G 43/02

(52) U.S. Cl. CPC B65G 43/02; B65G 2203/041

(57) ABSTRACT

The present invention relates to the technical field of mining belt conveyors, and particularly to a system for visually identifying and positioning a tearing fault of a conveyer belt of a mining belt conveyor. The system includes: an industrial camera, the industrial camera being fixedly mounted above a return conveyer belt and configured to collect a crack image of a surface of the conveyer belt of the belt conveyor; a belt speed sensor, the belt speed sensor being configured to collect a moving speed of the conveyer belt in real time; an industrial computer, the industrial computer being connected to the industrial camera and the belt speed sensor, and configured to determine whether the tearing fault has occurred on the conveyer belt according to the crack image of the surface of the conveyer belt of the belt conveyor collected by the industrial camera and to collect the moving speed of the conveyer belt collected by the belt speed sensor; and an industrial frequency converter, the industrial frequency converter being controlled by a logic controller, and the industrial frequency converter controlling a roller motor to align the position of the fault of the conveyer belt to a maintenance area.

### TECHNICAL FIELD

The present invention relates to the technical field of mining belt conveyors, and particularly to a system for visually identifying and positioning a tearing fault of a conveyer belt of a mining belt conveyor.

### BACKGROUND

At present, in the field of outward transport of underground materials, due to the advantages of a large transport volume and long-distance transportation, a belt conveyor is widely applied. During material transportation, impurities from materials or sharp objects such as angle iron stuck between a belt and a bracket as they fall off due to vibration of the conveyer belt easily scratch a bearing surface of the conveyer belt. The scratched belt can be detected by tearing detection devices such as a mechanical pull rope type detection device, an X-ray device and a weighing sensing type detection device. However, as the technique is not perfect enough, in actual application, a condition that the belt has been torn and the tearing detection device cannot detect the tearing has occurred. Moreover, due to the relatively long conveyer belt, in the case of a small-scale tearing fault, a maintenance worker can hardly find the fault point, which severely affects the maintenance time effect, further affecting the production efficiency of an enterprise.

### SUMMARY

To facilitate a worker to maintain the belt timely and conveniently to prevent a belt flying accident due to deterioration of the belt crack, so as to reduce the economic loss and guarantee the safety of personnel, the present invention provides a system for visually identifying and positioning a tearing fault of a conveyer belt of a mining belt conveyor.

The present invention uses the following technical solution: a system for visually identifying and positioning a tearing fault of a conveyer belt of a mining belt conveyor, including:
an industrial camera, the industrial camera being fixedly mounted above a return conveyer belt and configured to collect a crack image of a surface of the conveyer belt of the belt conveyor;
a belt speed sensor, the belt speed sensor being configured to collect a moving speed of the conveyer belt in real time;
an industrial computer, the industrial computer being connected to the industrial camera and the belt speed sensor, and configured to determine whether the tearing fault has occurred on the conveyer belt according to the crack image of the surface of the conveyer belt of the belt conveyor collected by the industrial camera and to collect the moving speed of the conveyer belt collected by the belt speed sensor; and
an industrial frequency converter, the industrial frequency converter being controlled by a logic controller, and the industrial frequency converter controlling a roller motor to align the position of the fault of the conveyer belt to a maintenance area.

In some embodiments, the step of determining whether the tearing fault has occurred on the conveyer belt by the industrial computer includes:
acquiring a split image of the crack of the conveyer belt through a PCNN;
extracting a region of interest;
boxing and calibrating a maximum contour of the crack;
calculating the area of the crack; and
determining tearing if the area of the crack exceeds a threshold.

In some embodiments, the position of the fault of the conveyer belt is aligned to the maintenance area by the following method:
S1: pasting a calibrated image below the conveyer belt, and making two marker lines M and N in the calibrated image, where a distance therebetween is L′;
S2: adjusting an angle and a focal distance of the industrial camera to enable an edge of the image to just coincide with the marker lines M and N, and keeping the position of the industrial camera unchanged;
S3: photographing a test image, and calculating a transverse pixel point value of the image, denoted as L″;
S4: calculating a proportional scale

$$φ , φ = \frac{{L}^{′}}{{L}^{″}} ;$$

S5: calculating an actual distance from a geometric center of the crack of the conveyer belt to the marker lines according to the proportional scale:

$${S}_{2}^{′} = {S}_{2} \cdot \frac{{L}^{′}}{{L}^{″}} ,$$

S2 representing a pixel distance from the geometric center of the crack of the conveyer belt to the edge of the image;
S6: calculating a shutdown distance

$$L = \frac{{L}_{1}}{cos θ} + {L}_{2} + {S}_{2}^{′} ,$$

θ being an included angle between the conveyer and a horizontal direction; and
S7: calculating a shutdown time according to the shutdown distance and inputting the shutdown time into the logic controller to enable the logic controller to control an electrified time of the roller motor to align the tearing position of the conveyer belt to the maintenance area.

In some embodiments, step S7 includes:
S71: calculating the number of turns n of rotation needed by a driving motor according to the shutdown time,

$$n = \frac{L}{D π} ;$$

S72: calculating an electrified time t of the driving motor according to the shutdown distance and a current speed v of the conveyer belt measured by the speed sensor,

$$t = \frac{L}{v} ;$$

S73: calculating the shutdown time,

$${t}_{0} = \frac{60 n}{N} , N = \frac{60 f}{p} ,$$

f being the frequency of the frequency converter, and p being the number of pole pairs of the motor; and
S74: inputting the shutdown time t₀ into the logic controller to enable the logic controller to control an electrified time t of the roller motor to align the tearing position of the conveyer belt to the maintenance area.

In some embodiments, the industrial camera and a return speed direction of the return conveyer belt form an included angle of 45°.

In some embodiments, the system for visually identifying and positioning a tearing fault of a conveyer belt of a mining belt conveyor further includes an illumination device, where the illumination device adopts a linear industrial illumination device, is fixed above the return conveyer belt and below the industrial camera and forms an included angle of 135° with the speed direction of the return conveyer belt.

In some embodiments, the belt speed sensor is mounted above the return conveyer belt and fixed on a carrier roller bracket, and a tension spring is arranged at the tail of the carrier roller bracket, so that a measuring wheel of the belt speed sensor clings to a surface of the return conveyer belt.

In some embodiments, the maintenance area is arranged at the tail to avoid the driving roller motor.

Compared with that prior art, the present invention has the following beneficial effects:

In the present invention, the system for visually identifying and positioning a tearing fault of a conveyer belt of a mining belt conveyor includes two parts: a tearing fault identification part and a fault point positioning part. The tearing fault identification part collects image information of the lower surface of the conveyer belt and transfers the image information back to the industrial computer. The industrial computer performs edge segmentation processing on the image information and determines whether the tearing fault occurs. If so, the distance from the geometric center of the crack to the calibration edge of the image is automatically measured, and is converted into the actual distance according to the calibrated proportional scale. In this case, the distance plus the distance from the position calibrated on the camera to the center of the maintenance area is the distance to move to align the tearing position with the maintenance area. Further, in combination with the current conveyer belt speed transferred back by the belt speed sensor, the number of turns of the driving roller to rotate can be calculated, and the tearing position of the conveyer belt can be automatically aligned to the designed maintenance area by the PLC in a combination of the frequency converter to control the driving roller motor, so that it is convenient for workers to maintain the tearing position timely.

### BRIEF DESCRIPTION OF THE DRAWINGS

FIG. 1 is a schematic diagram of aligning a maintenance area provided by an example of the present invention;

FIG. 2 is a flowchart of PCNN image segmentation processing provided by an example of the present invention;

FIG. 3 is a flowchart of identifying and positioning a tearing fault of a conveyer belt provided by an example of the present invention;

FIG. 4 is a schematic diagram of distance calibration by an industrial camera provided by an example of the present invention;

FIG. 5 is a calibrated pattern of the industrial camera provided by an example of the present invention;

FIG. 6 is an overall schematic diagram of a tearing fault visual identification and positioning system for the conveyer belt provided by an example of the present invention.

Description of reference numerals:
1, industrial camera bracket;
2, industrial camera;
3, maintenance area;
4, logic controller;
5, frequency converter;
6, industrial computer;
7, return conveyer belt;
8, belt speed sensor;
9, belt speed sensor bracket;
101, photographing view of industrial camera;
102, driving roller motor;
103, top view of maintenance area;
L1, distance from center of maintenance area to center of first carrier roller bracket;
L2, distance from first carrier roller bracket to marker line M;
θ , included angle between conveyer and horizontal direction;
D, diameter of driving roller;
401, camera calibrated grid chart;
402, crack image of conveyer belt processed by computer;
S1, actual distance from camera CMOS (sensor) to bottom of conveyer belt;
S2, horizontal distance from geometric center of crack in image to edge of view;
S3, vertical distance from geometric center of crack in image to edge of view;
M, marker line on right side of camera;
N, marker line on left side of camera;
L′, actual distance between marker lines M and N;
L″, horizontal pixel value of image.

### DETAILED DESCRIPTION OF THE EMBODIMENTS

In order to enable the above objectives, features, and advantages of the present disclosure to be more apparent and easily understood, specific embodiments of the present invention will be described in detail below with reference to the drawings. Many specific details are set forth in the following description to facilitate a full understanding of the present invention. However, the present invention may be implemented in many other ways different from those described herein, similar improvements may be made by those skilled in the art without departing from the connotation of the present invention, and therefore the present invention is not limited by particular examples disclosed below.

In the description of the present invention, it is to be noted that orientation or position relationships indicated by the terms: “central”, “vertical”, “upper”, “lower” and the like are orientation or position relationships indicated by the drawings and are only to describe the present invention and simplify the description rather than indicates or implies that the indicated device or components must have specific orientations and are configured and operated in the specific orientations. Therefore, it cannot be construed as limitations to the present invention.

Besides, in the present invention, unless otherwise explicitly specified and defined, the terms “mount”, “connect”, “fix” and the like shall be understood broadly. For example, it may be fixed connection or detached connection such as bolt connection or may be welded integrally, may be mechanical connection or electrical connection; or may be direct connection, unless otherwise explicitly defined. Those of ordinary skill in the art can understand specific meaning of the terms in the present invention under specific circumstances.

The embodiment provides a system for visually identifying and positioning a tearing fault of a conveyer belt of a mining belt conveyor, which has the advantages of identifying the tearing fault identification of the conveyer belt, aligning the tearing position to the maintenance area, reducing the economic loss, improving the maintenance efficiency and guaranteeing the safety of personnel. The system will be described in detail below in conjunction with drawings.

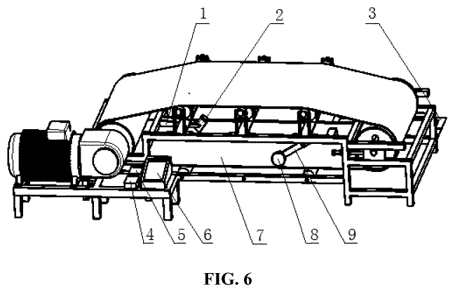

As shown in FIG. 6, a system for visually identifying and positioning a tearing fault of a conveyer belt of a mining belt conveyor includes:
an industrial camera 2, the industrial camera 2 being fixedly mounted above a return conveyer belt 7 and configured to collect a crack image of a surface of the conveyer belt of the belt conveyor;
a belt speed sensor 8, the belt speed sensor 8 being configured to collect a moving speed of the conveyer belt in real time;
an industrial computer 6, the industrial computer 6 being connected to the industrial camera 2 and the belt speed sensor 8, and configured to determine whether a tearing fault has occurred on the conveyer belt according to the crack image of the surface of the conveyer belt of the belt conveyor collected by the industrial camera 2 and to collect the moving speed of the conveyer belt by the belt speed sensor 8; and
an industrial frequency converter 5, the industrial frequency converter 5 being controlled by a logic controller 4, and the industrial frequency converter 5 controlling a roller motor to align the position of the fault of the conveyer belt to a maintenance area 3.

The industrial camera 2 and a return speed direction of the return conveyer belt 7 form an included angle of 45°.

The system for visually identifying and positioning a tearing fault of a conveyer belt of a mining belt conveyor further includes an illumination device, where the illumination device adopts a linear industrial illumination device, is fixed above the return conveyer belt 7 and below the industrial camera 2 and forms an included angle of 135° with the speed direction of the return conveyer belt 7.

The belt speed sensor 8 is mounted above the return conveyer belt 7 and fixed on a carrier roller bracket, and a tension spring is arranged at the tail of the carrier roller bracket, so that a measuring wheel of the belt speed sensor 8 clings to the surface of the return conveyer belt.

The maintenance area 3 is arranged at the tail to avoid the driving roller motor.

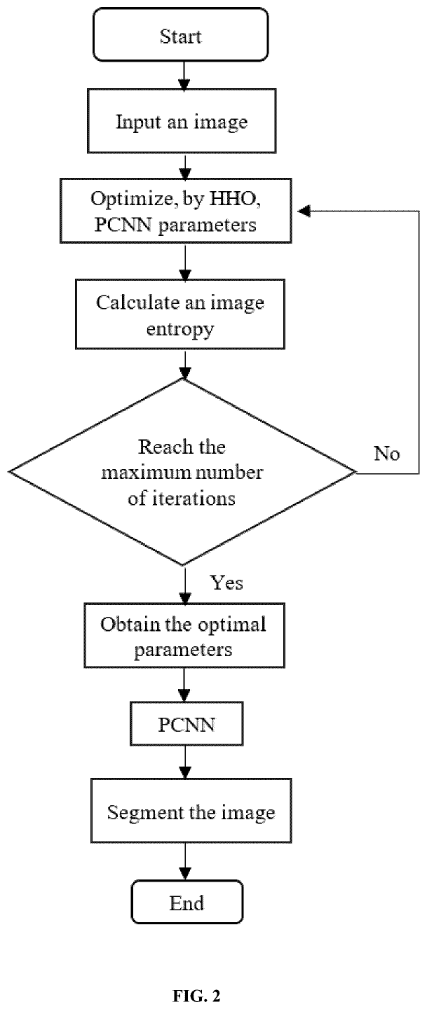

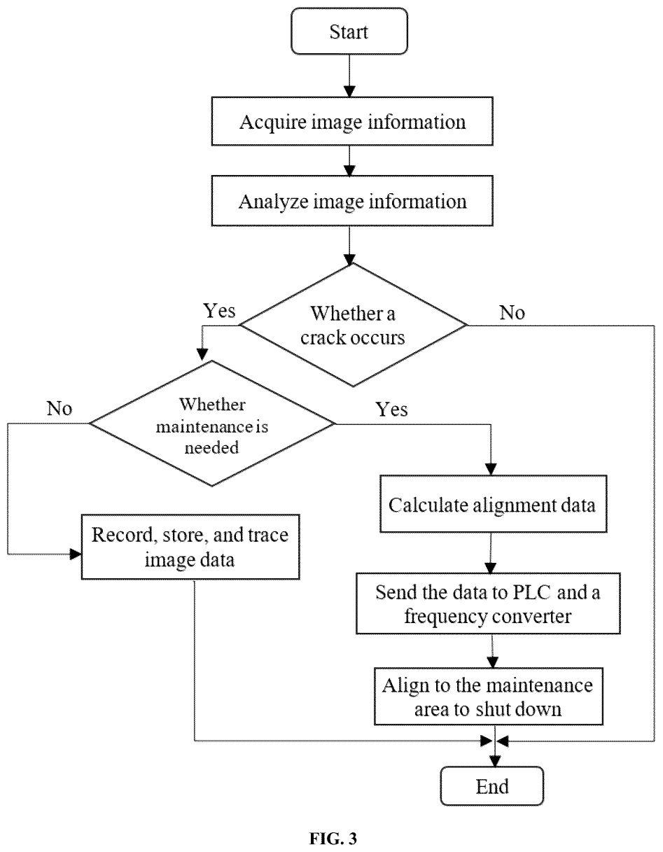

Identification of the tearing fault of the conveyer belt refers to FIG. 2.

The image of the conveyer belt acquired by the industrial computer is inputted into an algorithm, and operating number of iterations and recurrent formulae (1)-(5) are set to output the segmented image. A computer program determines whether the tearing fault occurs according to the segmented image.

A specific determination method includes: 1, acquiring a split image of the crack of the conveyer belt through a PCNN;
2, extracting a Region Of Interest (ROI) through a contour function in opencv;
3, counting pixel points in the ROI to calculate the area of the crack; and
4, determining tearing if the area of the crack exceeds a threshold.

In the case of the tearing fault, the shutdown parameters are calculated, and in the case of no tearing fault, a next frame of the image is continuously processed.

A PCNN model is developed on the basis of a neuron model put forward in accordance with a synchronous pulse discharge phenomenon of visual cortex nerves of the brains of mammals such as cats. One neuron includes three parts: an input, a modulation, and a pulse generator 3. The model of the neuron can be described by the following equations:

$${F}_{ij} [ n ] = {e}^{- {α}_{F}} {F}_{ij} [ n - 1 ] + {V}_{F} {\sum }_{kl} {M}_{ijkl} {Y}_{kl} [ n - 1 ] + {S}_{ij} \qquad ( 1 )$$

$${L}_{ij} [ n ] = {e}^{- {α}_{F}} {L}_{ij} [ n - 1 ] + {V}_{L} {\sum }_{k l} {W}_{ijkl} {Y}_{kd} [ n - 1 ] \qquad ( 2 )$$

$${U}_{ij} [ n ] = {e}^{- {α}_{F}} {F}_{ij} [ n ] \{ 1 + β {L}_{ij} [ n ] \} \qquad ( 3 )$$

$${E}_{ij} [ n ] = {e}^{- {α}_{E}} {E}_{ij} [ n - 1 ] + {V}_{E} {Y}_{ij} [ n ] \qquad ( 4 )$$

$${Y}_{ij} [ n ] = \{ \begin{matrix}1 , & {U}_{ij} [ n ] > {E}_{ij} [ n - 1 ] \\ 0 , & else\end{matrix} \qquad ( 5 )$$

where equation (1) represents a feedback input part of the model, Fᵢⱼ[n] represents a feedback input of the neuron at the coordinates (i, j) during n^{th} iteration, Sᵢⱼ represents an external excitation received by the neuron, which is correspondingly a gray value of a pixel of the image at the coordinates (i, j); Lᵢⱼ[n] in the equation (2) represents a link input part of the neuron, Mᵢⱼₖₗ and Wᵢⱼₖₗ represent linkage coefficients among neurons; equation (3) represents a modulation part, Uᵢⱼ[n] represents an internal action item of the neuron, which is modulated by the feedback input Fᵢⱼ[n] and the link input Lᵢⱼ[n], β represents a modulation coupling coefficient; Eᵢⱼ[n] in equation (4) represents a dynamic ignition threshold; equation (5) represents a neutron pulse generation part, which decides whether the neutron generates the pulse output or not by comparing the internal action item Uᵢⱼ[n] with the magnitude of the dynamic ignition threshold Eᵢⱼ[n−1]; in a case that Uᵢⱼ[n] is greater than Eᵢⱼ[n−1], the neutron is ignited to output Yᵢⱼ[n]=1, otherwise Yᵢⱼ[n]=0. Parameters V_{F}, V_{L}, and V_{E} respectively represent amplification coefficients of the feedback input, the link input, and the dynamic threshold.

The PCNN is formed by arranging single neutrons (usually a matrix). M and W usually transfer information among the neutrons locally and meet Gaussian normal distribution, which is not strictly required. When matrixes F, L, U, and Y are initialized, all matrix elements thereof are set to be 0. The initial value of the element E can be 0, and can also be set to be some large values according to actual demands. All neutrons with excitation will excitate excitement in the first cycle, resulting in a great threshold. Next, several cycles are needed to enable the threshold attenuate to re-excitate excitement by the neutrons. The latter tends to surround the initial cycles with a small amount of information.

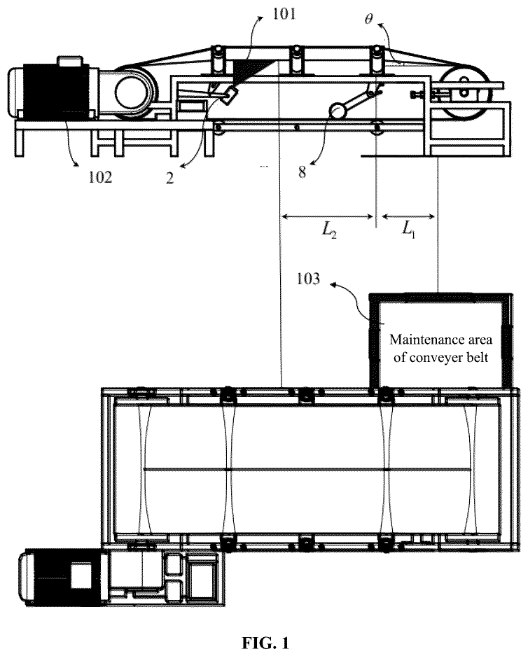

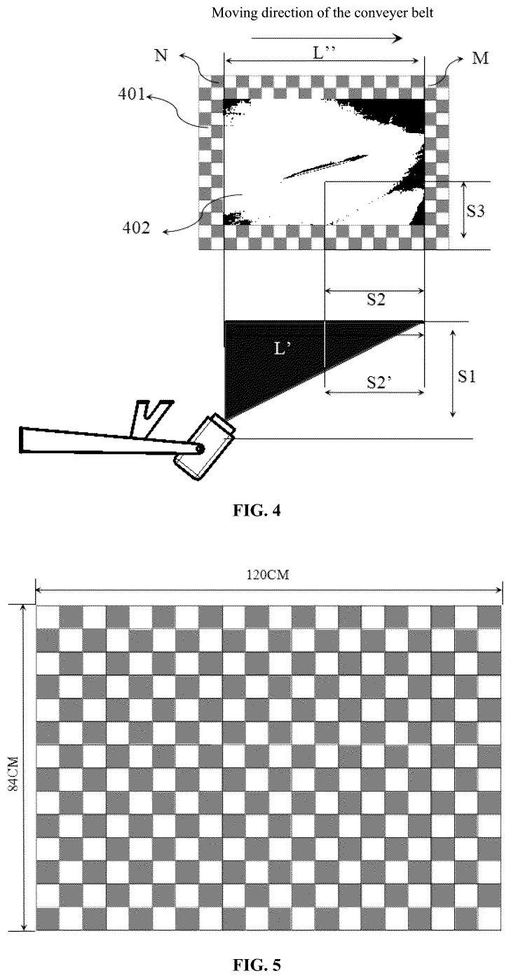

Positioning of the tearing fault of the conveyer belt refers to FIG. 1 and FIG. 4.

When the above-mentioned computer determines that the tearing fault occurs according to the image transferred back by the industrial camera, the computer will calculate an important parameter S2, which represents the pixel distance from the geometric center of the crack of the conveyer belt to the edge of the image. The parameter is multiplied by the actual proportional scale to obtain the actual distance from the geometric center of the crack of the conveyer belt to the positioning point M of the conveyer belt. The proportional scale is determined by camera calibration, including the following specific steps, as shown in FIG. 4:
1, pasting a calibrated image 401 below the conveyer belt, and making two marker lines M and N in the calibrated image, where the distance therebetween is known L′;
2, adjusting an angle and a focal distance of the camera to enable an edge of the image just be overlapping with the marker lines M and N;
3, locking the camera and keeping the position of the camera unchanged;
4, photographing a test image, calculating a transverse pixel point value of the image, and denoting the transverse pixel point value as L″;
5, representing the proportional scale φ as

$$φ = \frac{{L}^{′}}{{L}^{″}} .$$

Therefore, the actual distance from the geometric center of the crack of the conveyer belt to the marker lines is calculated by the following equation:

$${S}_{2}^{′} = {S}_{2} \cdot \frac{{L}^{′}}{{L}^{″}} \qquad ( 6 )$$

The shutdown distance is calculated:

Referring to FIG. 1, the shutdown distance is calculated by the following equation, where θ is an included angle between conveyer and horizontal direction:

$$L = \frac{{L}_{1}}{cos θ} + {L}_{2} + {S}_{2}^{′} \qquad ( 7 )$$

The number of turns n of rotation needed by a driving motor is calculated according to the shutdown time:

$$n = \frac{L}{D π} \qquad ( 8 )$$

An electrified time t of the driving motor is calculated according to the shutdown distance and a current speed v of the conveyer belt measured by the speed sensor:

$$t = \frac{L}{v} \qquad ( 9 )$$

A frequency of the frequency converter is given to calculate a rotating speed of the motor, where P is the number of pole pairs of the motor:

$$N = \frac{60 f}{p} \qquad ( 10 )$$

Finally, the shutdown time t₀ is calculated:

$${t}_{0} = \frac{60 n}{N} \qquad ( 11 )$$

Finally, the shutdown time t₀ is inputted into the PLC to enable the logic controller to control an electrified time t of the driving motor to align the tearing position of the conveyer belt to the maintenance area.

The technical features of the above embodiments may be combined freely. In order for brief description, the description is not made on all possible combinations of the technical features of the embodiments. However, the combinations of these technical features should be considered as a scope of the specification as long as there is no contradiction.

The above embodiments only express several embodiments of the present invention, and are described in more detail, but are not to be construed as a limitation to the scope of the applied patent. It shall be pointed out that several variations and modifications may also be made by those of ordinary skill in the art without departing from the spirit of the present invention, which all fall within the protection scope of the present invention. Therefore, the scope of protection of the patent for the present invention shall be subject to the appended claims.

1. A system for visually identifying and positioning a tearing fault of a conveyer belt of a mining belt conveyor, comprising:
an industrial camera, the industrial camera being fixedly mounted above a return conveyer belt and configured to collect a crack image of a surface of the conveyer belt of the belt conveyor;
a belt speed sensor, the belt speed sensor being configured to collect a moving speed of the conveyer belt in real time;
an industrial computer, the industrial computer being connected to the industrial camera and the belt speed sensor, and configured to determine whether the tearing fault has occurred on the conveyer belt according to the crack image of the surface of the conveyer belt of the belt conveyor collected by the industrial camera and to collect the moving speed of the conveyer belt collected by the belt speed sensor; and
an industrial frequency converter, the industrial frequency converter being controlled by a logic controller, and the industrial frequency converter controlling a roller motor to align the position of the fault of the conveyer belt to a maintenance area.

2. The system for visually identifying and positioning a tearing fault of a conveyer belt of a mining belt conveyor according to claim 1, wherein the step of determining whether the tearing fault has occurred on the conveyer belt by the industrial computer comprises:
acquiring a split image of the crack of the conveyer belt through a PCNN;
extracting an ROI through a contour function in opencv;
counting pixel points in the ROI to calculate the area of the crack; and
determining tearing if the area of the crack exceeds a threshold.

3. The system for visually identifying and positioning a tearing fault of a conveyer belt of a mining belt conveyor according to claim 1, wherein the position of the fault of the conveyer belt is aligned to the maintenance area by the following method:
S1: pasting a calibrated image below the conveyer belt, and making two marker lines M and N in the calibrated image, a distance therebetween being L′;
S2: adjusting an angle and a focal distance of the industrial camera to enable an edge of the image to just coincide with the marker lines M and N, and keeping the position of the industrial camera unchanged;
S3: photographing a test image, and calculating a transverse pixel point value of the image, denoted as L″;
S4: calculating a proportional scale φ,
$$φ = \frac{{L}^{′}}{{L}^{″}} ;$$
S5: calculating an actual distance from a geometric center of the crack of the conveyer belt to the marker lines according to the proportional scale φ:
$${S}_{2}^{′} = {S}_{2} \cdot \frac{{L}^{′}}{{L}^{″}} ,$$
S2 representing a pixel distance from the geometric center of the crack of the conveyer belt to the edge of the image;
S6: calculating a shutdown distance
$$L = \frac{{L}_{1}}{cos θ} + {L}_{2} + {S}_{2}^{′} ,$$
wherein θ being an included angle between the conveyer and a horizontal direction; and
S7: calculating a shutdown time according to the shutdown distance and inputting the shutdown time into the logic controller to enable the logic controller to control an electrified time of the roller motor to align the tearing position of the conveyer belt to the maintenance area.

4. The system for visually identifying and positioning a tearing fault of a conveyer belt of a mining belt conveyor according to claim 3, wherein step S7 comprises:
S71: calculating the number of turns n of rotation needed by a driving motor according to the shutdown time,
$$n = \frac{L}{D π} ;$$
S72: calculating an electrified time t of the driving motor according to the shutdown distance and a current speed v of the conveyer belt measured by the speed sensor,
$$t = \frac{L}{v} ;$$
S73: calculating the shutdown time,
$${t}_{0} = \frac{60 n}{N} , N = \frac{60 f}{p} ,$$
f being the frequency of the frequency converter, and P being the number of pole pairs of the motor; and
S74: inputting the shutdown time t₀ into the logic controller to enable the logic controller to control an electrified time t of the roller motor to align the tearing position of the conveyer belt to the maintenance area.

5. The system for visually identifying and positioning a tearing fault of a conveyer belt of a mining belt conveyor according to claim 1, wherein the industrial camera and a return speed direction of the return conveyer belt form an included angle of 45°.

6. The system for visually identifying and positioning a tearing fault of a conveyer belt of a mining belt conveyor according to claim 1, further comprising an illumination device, wherein the illumination device adopts a linear industrial illumination device, is fixed above the return conveyer belt and below the industrial camera and forms an included angle of 135° with the speed direction of the return conveyer belt.

7. The system for visually identifying and positioning a tearing fault of a conveyer belt of a mining belt conveyor according to claim 1, wherein the belt speed sensor is mounted above the return conveyer belt and fixed on a carrier roller bracket, and a tension spring is arranged at the tail of the carrier roller bracket, so that a measuring wheel of the belt speed sensor clings to a surface of the return conveyer belt.

8. The system for visually identifying and positioning a tearing fault of a conveyer belt of a mining belt conveyor according to claim 1, wherein the maintenance area is arranged at the tail to prevent the roller motor from being driven.
